(19) United States
(12) Patent Application Publication
(10) Pub. No.: US 2015/0219962 A1
(43) Pub. Date: Aug. 6, 2015

(54) TRANSFLECTIVE DISPLAY WITH A LIGHT-RECYCLING MODULATION LAYER

(71) Applicant: HEWLETT-PACKARD DEVELOPMENT COMPANY, LP, Houston, TX (US)

(72) Inventors: Gary Gibson, Palo Alto, CA (US); Richard H. Henze, Palo Alto, CA (US); Xia Sheng, Palo Alto, CA (US)

(21) Appl. No.: 14/421,238

(22) PCT Filed: Sep. 30, 2012
(86) PCT No.: PCT/US2012/058200

§ 371 Date: Feb. 12, 2015

(51) Int. Cl. G02F 1/1335; F21V 8/00

(52) U.S. Cl. CPC G02F 1/133605; G02F 1/133555; G02F 1/133514; G02F 1/133536; G02B 6/0001; G02F 2001/133614; G02F 2001/133618; G02F 2001/13355

(57) ABSTRACT

A transflective display pixel includes a sub-pixel with a light-recycling modulation layer, a luminescent layer, and a selective reflector layer and a backlight source to provide backlight to the sub-pixel. The light-recycling modulation layer is to reflect light from the luminescent layer having a first polarization state, and the selective reflector layer is to reflect light from the luminescent layer in a first waveband. The selective reflector layer is to transmit the backlight to the luminescent layer, and the luminescent layer converts light from the light-recycling modulation layer and the backlight into the first waveband.

### BACKGROUND

A reflective display is a device in which ambient light is used for viewing the displayed information by reflecting desired portions of the incident ambient light spectrum back to a viewer. Because these displays rely on ambient light, the displays often have a difficult time effectively displaying a full color gamut with sufficient brightness. As a result, reflective displays are generally not able to provide adequate performance for the display of full color images. In addition, the use of supplementary light sources with reflective displays can present difficulties when employing conventional shutter technologies.

### BRIEF DESCRIPTION OF THE DRAWINGS

FIG. 1 is a block diagram illustrating one example of a transflective display pixel with a light-recycling modulation layer.

FIG. 2 is a block diagram illustrating one example of a light-recycling modulation layer.

FIGS. 3A-3B are block diagrams illustrating examples of a luminescence layer.

FIG. 4 is a block diagram illustrating one example of a low index layer for optically coupling light from a luminescent layer.

FIG. 5 is a block diagram illustrating one example of out-coupling structures for optically coupling light from a luminescent layer.

FIGS. 6A-6B are block diagrams illustrating examples of a backlight source.

FIG. 7 is a block diagram illustrating one example of a low index layer for optically coupling backlight from a backlight source.

FIG. 8 is a schematic diagram illustrating one example of transflective display device that includes a transflective display with a transflective display pixel having a light-recycling modulation layer.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

The term “light” refers to electromagnetic radiation having wavelengths in and around the visible spectrum, including ultraviolet and infrared wavelengths. The term “ambient light” refers to available light in an environment having a spectral profile in the visible spectrum. The term “red light” refers to light that generally ranges from wavelengths of 580 to 650 nm. The term “green light” refers to light that generally ranges from wavelengths of 490 to 580 nm. The term “blue light” refers to light that generally ranges from wavelengths of 400 to 490 nm. The term “ultraviolet light” refers to light that generally ranges from wavelengths of 100 to 400 nm.

As described herein, a transflective display that provides high power efficiency and video rate operation is provided. The transflective display includes a light-recycling modulation layer that reflects one polarization of light back to a luminescent layer, where the luminescent layer recycles the light by absorbing it and re-emitting it with a random polarization, in this manner allowing the light to eventually pass through the modulation layer in its open state, thereby enhancing the brightness of the display. Additional layers, such as a selective reflector layer and a reflecting surface of a backlight source, may also include structural features that randomize the polarization state of the reflected light to further the light recycling. The light-recycling modulation layer includes a liquid crystal shutter layer and a reflecting polarizer in some examples.

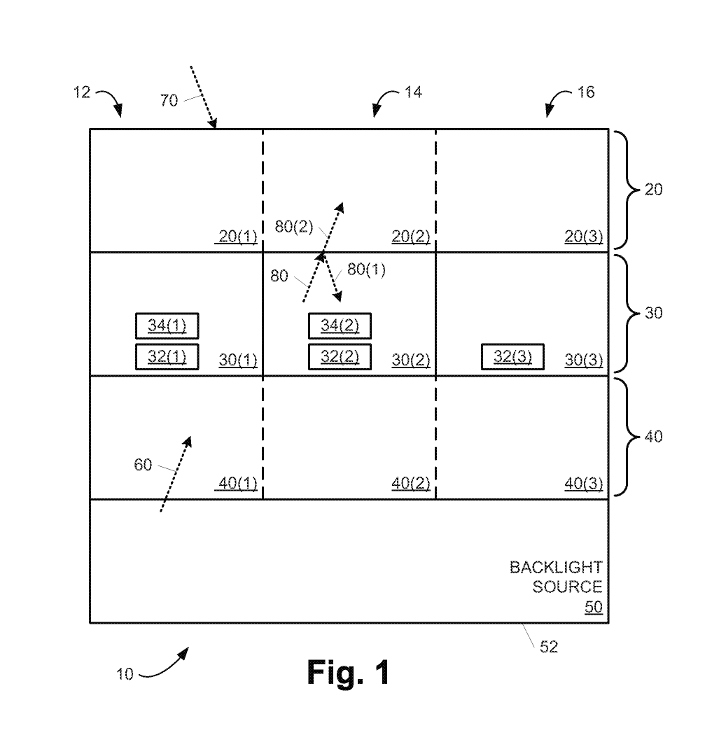

FIG. 1 is a block diagram illustrating one example of a transflective display pixel 10 with a light-recycling modulation layer 20 for use in a transflective display. Transfiective display 10 operates to modulate backlight 60 from a backlight source 50, ambient light 70, and photoluminescent light 80 from a luminescent layer 30 using light-recycling modulation layer 20 to produce still or video images and/or patterns for viewing by a person in proximity to display 10.

In transflective display 10, a luminescent layer 30 is disposed below light-recycling modulation layer 20, a selective reflector layer 40 is disposed below luminescent layer 30, and backlight source 50 is optically coupled to luminescent layer 30 through selective reflector layer 40 to provide backlight 60 to a luminescent layer 30.

Light-recycling modulation layer 20 includes a layer or a set of layers that that transmit one polarization state of light in one operating state (e.g., an “on” state) and no light in another operating state (e.g., an “off” state). The transmitted light includes light contributed from backlight 60, ambient light 70, and photoluminescent light 80. Light-recycling modulation layer 20 may also includes intermediate states (e.g., gray states) where only some light from a given polarization state is transmitted.

Light-recycling modulation layer 20 recycles photoluminescent light 80 by reflecting one polarization state 80(1) of light 80 back into luminescent layer 30 until light 80(1) has the correct polarization state 80(2) to pass through light-recycling modulation layer 20 when light-recycling modulation layer 20 is in the “on” state. Photoluminescent light 80 may be stimulated from backlight 60 and ambient light 70 that reaches luminescent layer 30.

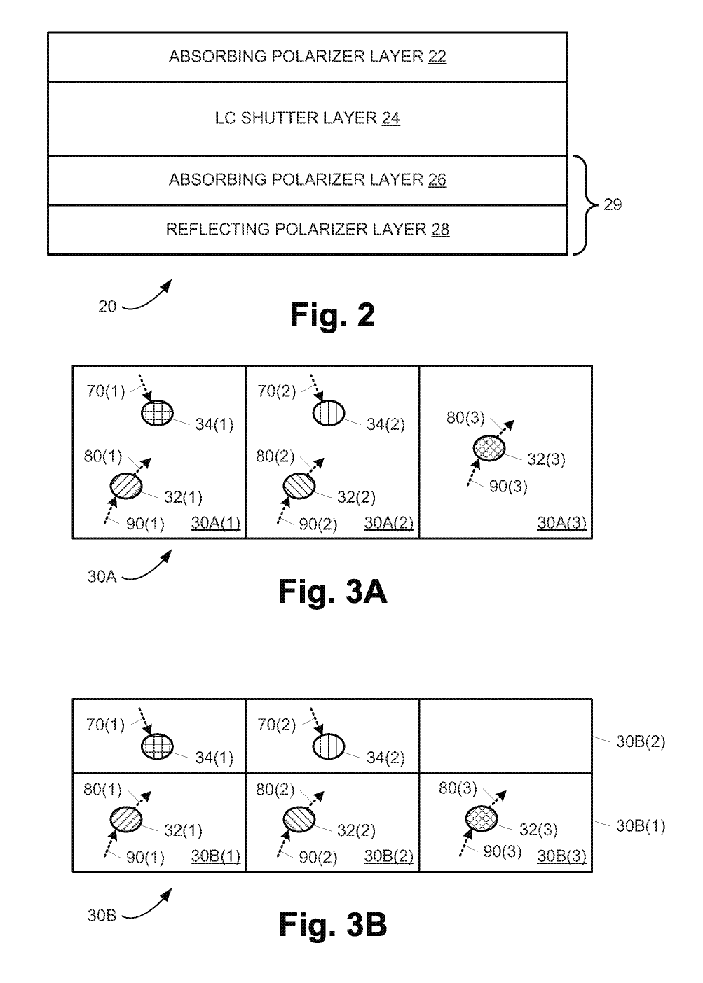

Light-recycling modulation layer 20 includes first, second, and third layers 20(1)-20(3) with respective liquid crystal (LC) shutters 24(1)-24(3) (shown in FIG. 2) in corresponding sub-pixel 12, 14, and 16. Luminescent layer 30 similarly includes first, second, and third layers 30(1)-30(3)), corresponding to sub-pixels 12, 14, and 16, respectively, with respective luminescent materials 32(1)-32(3). Layer 30(1) may not include luminescent material 32(1) in some embodiments. Selective reflector layer 40 includes portions 40(1)-40(3) with a uniform composition across portions 40(1)-40(3) as indicated by dashed lines in layer 40 in FIG. 1.

FIG. 2 is a block diagram illustrating one example of light-recycling modulation layer 20 for each layer 20(1)-20(3). Light-recycling modulation layer 20 includes a first absorbing polarizer layer 22, a liquid crystal (LC) shutter layer 24 is disposed below first absorbing polarizer layer 22, a second absorbing polarizer layer 26 disposed below LC shutter layer 24, and a reflecting polarizer layer 28 disposed below second absorbing polarizer layer 26. Absorbing polarizer layer 26 and reflecting polarizer layer 28 may be combined to form a unidirectional reflecting polarizer layer (i.e. a polarizer layer that passes light of one polarization state and either reflects or absorbs the other polarization state depending upon which direction the light is incident from) in some embodiments.

Absorbing polarizer layer 22, LC shutter layer 24, second absorbing polarizer layer 26 and reflecting polarizer layer 28 may be configured in any suitable arrangement that transmits one polarization state of light in one operating state (e.g., an “on” state) and no light in another operating state (e.g., an “off” state) where the polarizations of light may be linear, circular, or elliptical, for example. In one example that uses linear polarizations, absorbing polarizer 22 is either orthogonal or aligned with both second absorbing polarizer 26 and reflecting polarizer 28, and LC shutter (e.g., a twisted nematic LC) either rotates or does not rotate the polarization of the light by 90 degrees to provide the operating states.

LC shutter layer 24 is disposed below disposed below first absorbing polarizer layer 22 and includes an LC shutter for each sub-pixel with a liquid crystal material to modulate the light. All LC shutters may be turned to the “on” state to produce a white appearance (i.e., white light) and turned to the “off” state to produce a black appearance. Combinations of LC shutters may be opened or partially opened to achieve color states with various gray levels. In other embodiments, LC shutter layer 24 may be replaced with another suitable shutter layer with shutters that modulate one polarization state of light.

For ambient light 70, absorbing polarizer layer 22 transmits one polarization state of ambient light 70 and absorbs an orthogonal polarization state of ambient light 70. The LC shutter either alters or leaves unchanged the polarization state of ambient light 70 that passes through absorbing polarizer 22 to cause the light to either pass through absorbing polarizer 26 and reflecting polarizer 28 or be absorbed by absorbing polarizer 26.

Light passing out of luminescent layer 30 may include photoluminescent light 80, reflected light from selective reflector layer 40 and/or backlight source 50, and/or light provided by backlight source 50. For light passing out of luminescent layer 30, reflecting polarizer 28 transmits one polarization state of light and reflects an orthogonal polarization state. The LC shutter either alters or leaves unchanged the polarization state of the light that passes through reflecting polarizer 28 and absorbing polarizer 26 to cause this light to either pass through absorbing polarizer 22 or be blocked by absorbing polarizer 22.

A passive or active matrix (not shown) may be included to drive the LC shutters in LC shutter layer 24. The matrix may disposed below backlight source 50 with electrical vias up to LC shutter layer 24, or this matrix may be transparent and incorporated between LC shutter layer 24 and absorbing polarizer 26, for example.

FIGS. 3A-3B are block diagrams illustrating examples 30A and 30B of sub-pixel layer 30. Sub-pixel layer 30 may be formed from luminescent films that include luminescent materials 32(1)-32(3). Absorbers 34(1)-34(2) may be in the same layer as luminescent materials 32(1)-32(2) as shown in sub-pixel layer 30A in FIG. 3A or in separate layers 30B(1) and 30B(2) as shown in sub-pixel layer 30B in FIG. 3B. The description below will use sub-pixels 30(1)-30(3) to refer to the functions of sub-pixels 30A(1)-30A(3) in luminescent layer 30A and sub-pixels 30B(1)-30B(3) in luminescent layer 30B.

Light 90(1)-90(3), which includes backlight 60 and ambient light 70, stimulates unpolarized emissions 80(1)-80(3) from luminescent materials 32(1)-32(3), respectively. For each emission 80(1)-80(3), one polarization state makes it through reflecting polarizer 28 (shown in FIG. 2) immediately and the other is reflected. The polarization state of the reflected light can be randomized through various processes. These processes include, re-absorption followed by re-emission of the light by luminescent materials 32(1)-32(3) (or luminescent materials 32(2) and 32(3) if luminescent material 32(1) is omitted), and optical scattering within luminescent layer 30 or at the surface of selective reflector layer 40 or the surface of backlight source 50 by non-polarization preserving scattering structures (e.g. small particles with a high refractive index). If luminescent material 32(1) is omitted, this mixing of the polarization states also applies to blue backlight 60 so that it can eventually be passed through reflecting polarizer 28. After several attempts, the majority of photoluminescent light 80(1)-80(3) will pass through reflecting polarizer 28, particularly because the luminescent films in luminescent layer 30 and selective reflector layer 40 may be made relatively lossless. Thus, the efficiency with which the light from backlight source 50 is converted to light that reaches the viewer (i.e., light that passes through reflecting polarizer 28 and absorbing polarizer 26 and is altered or left unchanged to cause it to pass through absorbing polarizer 22) may be quite high in the ‘on’ state of the LC shutters.

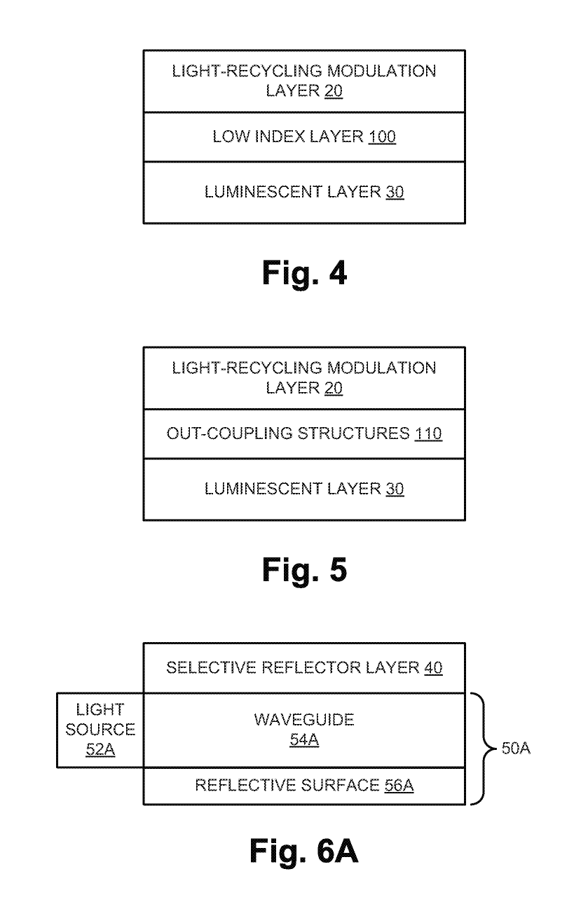

To improve the out-coupling of photoluminescent light 80(1)-80(3) in sub-pixels 30(1)-30(3), selective reflector layer 40 may be made somewhat diffuse and a low refractive index layer 100 may be included above luminescent layer 30 and below light-recycling modulation layer 20 as shown in FIG. 4. Alternatively, out-coupling structures 110, such as a lenslet array, may be included above luminescent layer 30 and below light-recycling modulation layer 20 as shown in FIG. 5. Low refractive index layer 100 and out-coupling structures 110 may serve to effectively re-cycle the light within luminescent layer 30 until it is partially collimated, which improves the odds of the light making through light-recycling modulation layer 20. Additional details regarding out-coupling may be found in PCT International Publication Number WO2011/133152A1, entitled “LUMINESCENCE-BASED REFLECTIVE PIXEL”, filed on Apr. 22, 2010. This application is incorporated by reference herein.

Referring back to FIG. 1, sub-pixel 12 includes light-recycling modulation layer 20(1) with LC shutter 24(1), luminescent layer 30(1) with or without luminescent material 32(1) and with absorbing material 34(1), and portion 40(1) of selective reflector layer 40. Sub-pixel 14 includes light-recycling modulation layer 20(2) with LC shutter 24(2), luminescent layer 30(2) with luminescent material 32(2) and absorbing material 34(2), and portion 40(2) of selective reflector layer 40. Sub-pixel 16 includes light-recycling modulation layer 20(3) with LC shutter 24(3), luminescent layer 30(3), and portion 40(3) of selective reflector layer 40.

Sub-pixels 12, 14, and 16 convert most of the received ambient light to their respective colors via emission of unpolarized light, one polarization of which passes back through light-recycling modulation layer 20 when it is in the open state. Sub-pixels 12, 14, and 16 also absorb some wavelengths of the received ambient light in sub-pixels 12 and 14 using absorbing materials 34(1) and 34(2), respectively, and pass some of the received ambient light to selective reflector layer 40. For the light from sub-pixels 12, 14, and 16 (e.g., ambient light 70 and reflected light 80(1)), selective reflector layer 40 reflects light in the reflective waveband (e.g., red and green light) back to sub-pixels 12, 14, and 16 and transmits the remaining light to backlight source 50 where it is reflected back to selective reflector layer 40.

Sub-pixels 12, 14, and 16 will be described herein as being blue, green, and red sub-pixels 12, 14, and 16, respectively, that produce blue, green, and red light, respectively, using luminescent materials 32(1)-32(3) when present. In other examples, sub-pixels 12, 14, and 16 may have any other suitable primary colors, and different numbers of sub-pixels may be used for each transflective pixel 10 including a single sub-pixel. Sub-pixels 12 and 14 also include absorbing materials 34(1) and 34(2), respectively, to absorb red and green light in sub-pixel 12 and red light in sub-pixel 14, respectively.

Blue sub-pixel 12 may include a blue-emitting luminescent material 32(1) (e.g., a blue-emitting luminophore or a series of blue-emitting luminophores) that converts shorter ambient and backlight wavelengths in light 90(1), possibly including near ultraviolet wavelengths, to blue light 80(1). In embodiments where backlight source 50 produces blue light, blue-emitting luminescent material 32(1) may be omitted. Blue sub-pixel 12 also includes a red-green absorber 34(1) to absorb red and green ambient light 70(1) which cannot be efficiently up-converted to blue light.

Green sub-pixel 14 includes a green-emitting luminescent material 32(2) (e.g., a green-emitting luminophore or a series of green-emitting luminophores) that converts shorter ambient and backlight wavelengths in light 90(2) to green light 80(2). Green sub-pixel 30(2) also includes a red absorber 34(2) to absorb red ambient light 70(2) which cannot be efficiently up-converted to green light.

Red sub-pixel 16 includes a red-emitting luminescent material 32(3) (e.g., a red-emitting luminophore or a series of red-emitting luminophores) that converts a broad spectrum of shorter ambient and backlight wavelengths in light 90(3) to red light 80(3).

Luminescent materials 32(1)-32(3) may be a series of organic relay dyes in a transparent host polymer in some embodiments.

Selective reflector layer 40 transmits light from the waveband of backlight source 50 and reflects light in a reflective waveband of selective reflector layer 40 that is at wavelengths longer than the waveband of backlight source 50. In particular, selective reflector layer 40 transmits light 60 from backlight source 50 to luminescent layers 30(1)-30(3) where the respective luminescent materials, if present, convert light 60 from the waveband of backlight source 50 to blue, green, and red light, respectively. In the example of FIG. 1, selective reflector layer 40 is an unpatterned dichroic mirror that transmits blue light and reflects red and green light. Selective reflector layer 40 may be made from a Bragg stack, a reactive mesogen cholesteric film, or photonic and plasmonic structures (see, e.g, Peters, et al., J.A.P. 105, 014909 (2009) for examples of wavelength-selective photonic structures). Selective reflector layer 40 may include a surface with non-polarization preserving scattering structures (e.g. small particles with a high refractive index) as noted above.

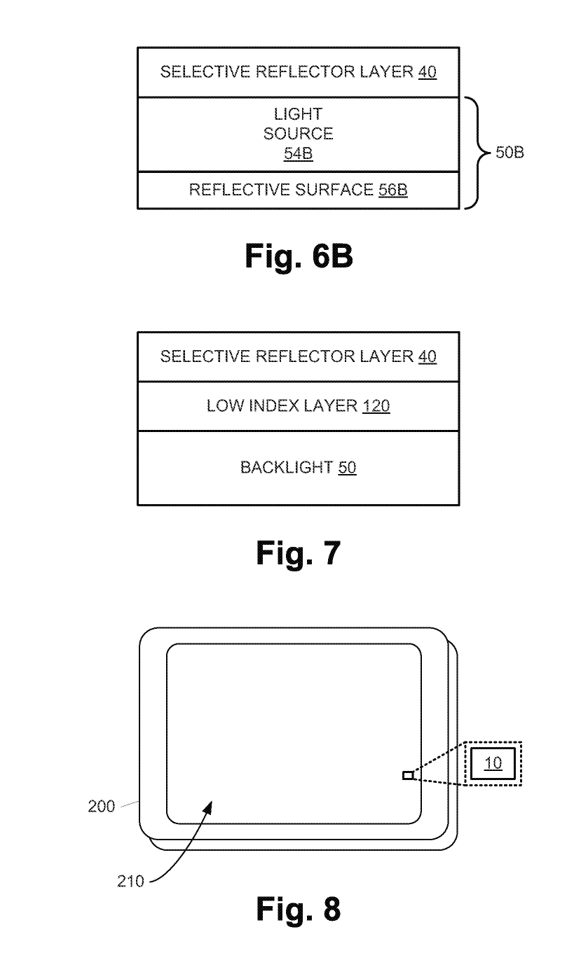

As noted above, backlight source 50 is optically coupled to luminescent layer 30 and produces backlight 60 from a desired waveband from a spectrum that ranges from blue to ultraviolet, such as blue, deep blue, near ultraviolet, and/or ultraviolet light. FIGS. 6A-6B are block diagrams illustrating examples 50A and 50B of backlight source 50.

In FIG. 6A, backlight source 50A includes a light source 52A, a waveguide 54A disposed below selective reflector layer 40, and a reflective surface 56A opposite selective reflector layer 40 on the bottom of waveguide 54A.

Waveguide 54A is a transparent, relatively high refractive index layer that serves as an optical waveguide for the light produced by light source 52A and is deposited on reflective surface 56A that covers the display area. Near the perimeter of waveguide 54A, light source 52A is positioned so as to couple light into waveguide 54A. Light source 52A may be at the edge of waveguide 54A as shown, or along the top or bottom surface of the waveguide (not shown). In other examples, multiple light sources 52A may be used at multiple positions around waveguide 54A. Light source 52A may, for example, be a blue-emitting OLED based on organic polymers or an inorganic diode such as those based on InₓGa₁₋ₓN or other III-V compounds. Light source 52A may also produce deep blue, near ultraviolet, and/or ultraviolet light in other examples. Reflective surface 56A may reflect only blue wavelengths or it may be a broadband reflector such as a Ag or Al film. Reflective surface 56A may include optical scattering structures (not shown) that scatter light 60 out of waveguide 54A and through selective reflector layer 40. These may be distributed across reflective surface 56A or within waveguide 54A in a manner that provides uniform back-illumination of the display. The structures may also randomize the polarization state of the light reflected by reflective surface 56A.

Referring to FIG. 7, a low refractive index layer 120 may be included above waveguide 54A to help define the optical waveguide and reduce the amount of light leaving waveguide 54A per unit area as the light travels down waveguide 54A away from light source 52A.

In FIG. 6B, backlight source 50A includes a distributed light source 52B disposed below selective reflector layer 40 and a reflective surface 56B opposite selective reflector layer 40 on the bottom of light source 52B. Distributed light source 52B may be a blue-emitting organic LED with a transparent top electrode and reflective bottom electrode that forms reflective surface 56B. Reflective surface 56B may reflect only blue wavelengths or it may be a broadband reflector.

Distributed light source 52B may also be divided into separately controlled patches, each of which underlies one or a few pixels in luminescent layer 30. When additional light is desired in a given region, a corresponding portion of distributed light source 52B may be powered to a desired level to save power overall.

FIG. 8 is a schematic diagram illustrating one example of transflective display device 200 that includes transflective display 210 with an array of transflective display pixels 10.

Transfiective display device 200 includes any suitable type of device configured to display images by selectively controlling the array of pixels 10 using ambient light and backlight as described above. Transfiective display device 200 may represent any suitable type of display device for use as a stand alone display (e.g., a retail sign) or for use as part of a tablet, pad, laptop, or other type of computer, a mobile telephone, an audio/video device, or other suitable electronic device. Transflective display device 200 may include any suitable input devices (not shown), such as a touchscreen, to allow a user to control the operation of device 200. Transfiective display device 200 may also include memory (not shown) for storing information to be displayed, one or more processors for processing information to be displayed, and a wired or wireless connection device for accessing additional information to be displayed or processed for display.

The above embodiments may advantageously use backlight more efficiently than typical displays that include a white backlight with color filters where approximately two-thirds of the light is absorbed in the filters. The embodiments may use a majority of the backlight emission when the sub-pixels are “on.” The embodiments enable the use of LC technology with reflective light to facilitate video rate operation and high contrast ratios. In addition, the embodiments supplement the backlight through the use of a substantial fraction of available ambient light. The embodiments may also have a cost advantage relative to displays that use area-selective colored backlights (eg. LEDs) because a relatively simple backlight at the perimeter may be used.

What is claimed is:

1. A transflective display comprising:
a sub-pixel including:
a light-recycling modulation layer;
a luminescent layer disposed below the light-recycling modulation layer; and
a selective reflector layer disposed below the luminescent layer; and
a backlight source optically coupled to the sub-pixel to provide backlight to the sub-pixel;
wherein the light-recycling modulation layer is to reflect light from the luminescent layer having a first polarization state, wherein the selective reflector layer is to reflect light from the luminescent layer in a first waveband, wherein the selective reflector layer is to transmit the backlight to the luminescent layer, and wherein the luminescent layer converts light from the light-recycling modulation layer and the backlight into the first waveband.

2. The transflective display of claim 1 wherein the sub-pixel includes an absorbing material to absorb light from a second waveband that differs from the first waveband.

3. The transflective display of claim 1 wherein the light-recycling modulation layer includes:
a first absorbing polarizer layer;
a liquid crystal (LC) shutter layer disposed below the first absorbing polarizer layer to selectively alter the first or a second polarization state of light that is orthogonal to the first polarization state; and
a unidirectional reflecting polarizer layer disposed below the LC shutter layer to absorb light from the LC shutter layer having the first polarization state, transmit the light from the LC shutter layer having the second polarization state, reflect the light from the luminescent layer having the first polarization state, and transmit the light from the luminescent layer having the second polarization state.

4. The transflective display of claim 3 wherein the unidirectional reflecting polarizer layer includes a second absorbing polarizer layer and a reflecting polarizer layer.

5. A transflective display comprising:
a color pixel including:
a first sub-pixel having a first light-recycling modulation layer, a first luminescent layer disposed below the first light-recycling modulation layer, and a first portion of a selective reflector layer disposed below the first luminescent layer; and
a second sub-pixel having a second light-recycling modulation layer, a second luminescent layer disposed below the second light-recycling modulation layer, and a second portion of the selective reflector layer disposed below the second luminescent layer; and
a backlight source optically coupled to the color pixel to provide backlight to the first sub-pixel and the second sub-pixel;
wherein the first and the second light-recycling modulation layers are to reflect light from the first and the second luminescent layers having a first polarization state, wherein the selective reflector layer is to reflect light from the first and the second luminescent layers in a waveband, wherein the selective reflector layer is to transmit the backlight to the first and the second luminescent layers, wherein the first luminescent layer converts light from the first light-recycling modulation layer and the backlight into a first color within the waveband, and wherein the second luminescent layer converts light from the second light-recycling modulation layer and the backlight into a second color within the waveband.

6. The transflective display of claim 5 wherein the color pixel includes a third sub-pixel having a third light-recycling modulation layer and a first absorbing material disposed below the third light-recycling modulation layer, and wherein the first absorbing material absorbs light of the first and the second colors.

7. The transflective display of claim 6 wherein third sub-pixel has a third luminescent layer disposed below the third light-recycling modulation layer, and wherein the third luminescent layer converts light from the third light-recycling modulation layer and the backlight into a third color that is outside of the waveband.

8. The transflective display of claim 7 wherein the second sub-pixel includes a second absorbing material to absorb light of the first color.

9. The transflective display of claim 8 wherein the backlight source provides the backlight with light of the third color but not light of the first color or the second color.

10. The transflective display of claim 5 wherein the backlight provides blue light, deep blue light, near ultraviolet light, or ultraviolet light.

11. The transflective display of claim 5 wherein the backlight includes a light source, a waveguide to optically couple light from the light source to the selective reflector layer, and a reflective surface.

12. The transflective display of claim 11 wherein the reflective surface includes optical scattering structures to scatter the backlight out of the waveguide and through the selective reflector layer.

13. The transflective display of claim 5 wherein the backlight includes a distributed light source disposed below the selective reflector layer.

14. The transflective display of claim 5 wherein the first light-recycling modulation layer includes:
a first absorbing polarizer layer;
a liquid crystal (LC) shutter layer disposed below the first absorbing polarizer layer to selectively alter the first or a second polarization state of light that is orthogonal to the first polarization state;
a second absorbing polarizer layer disposed below the LC shutter layer to absorb light from the LC shutter layer having the first polarization state and transmit the light from the LC shutter layer having the second polarization state to the first luminescent layer; and
a reflecting polarizer to reflect the light from the first luminescent layer having the first polarization state and transmit the light from the first luminescent layer having the second polarization state.

15. A transflective display comprising:
a color pixel including:
a red sub-pixel having a first light-recycling modulation layer, red-emitting luminescent material disposed below the first light-recycling modulation layer, and a first portion of a selective reflector layer disposed below the first luminescent layer;
a green sub-pixel having a second light-recycling modulation layer,
green-emitting luminescent material disposed below the second light-recycling modulation layer, a red absorbing material, and a second portion of the selective reflector layer disposed below the second luminescent layer;
a blue sub-pixel having a third light-recycling modulation layer, a red-green absorbing material disposed below the third light-recycling modulation layer, and a third portion of the selective reflector layer disposed below the red-green absorbing material;
each of the first, the second and the third light-recycling modulation layers including a respective first absorbing polarizer, a respective liquid crystal (LC) shutter layer disposed below the respective first polarizer layer, a respective second absorbing polarizer disposed below the respective LC shutter layer, and a respective reflecting polarizer disposed below the respective second absorbing polarizer; and
a backlight optically coupled to the pixel to provide at least one of blue, deep blue, near ultraviolet, or ultraviolet backlight to the red sub-pixel, the green sub-pixel, and the blue sub-pixel;
wherein the selective reflector layer is to reflect red and green light, wherein the selective reflector layer is to transmit light from the backlight.
